(19) United States
(12) Patent Application Publication
(10) Pub. No.: US 2004/0135007 A1
(43) Pub. Date: Jul. 15, 2004

(54) Atomizing nozzle with anodized aluminum body

(76) Inventor: Nathan Palestrant, Scottsdale, AZ (US)

Correspondence Address: Jordan M. Meschkow, Meschkow & Gresham, PLC, Suite 409, 5727 North 7th Street, Phoenix, AZ, 85014, US

(21) Appl. No.: 10/698,777

(22) Filed: Oct. 30, 2003

Related U.S. Application Data
(60) Provisional application No. 60/436,711, filed on Dec. 27, 2002.

(51) Int. Cl. B05B 1/34

(52) U.S. Cl. 239/492

(57) ABSTRACT

An anodized aluminum atomizing nozzle (20) for use in a misting system and a process (200) for manufacturing the atomizing nozzle (20) are provided. The atomizing nozzle (20) is made up of a nozzle body (22), an orifice insert (24), and an impeller (26). The nozzle body (22) has an inlet end (30), has an outlet end (32), has an insert recess (54) proximate the outlet end (32), and encompasses a first chamber (60). The orifice insert (24) is affixed to the nozzle body (22) within the insert recess (54) and encompasses a second chamber (94). The impeller (26) is configured to reside within the first and second chambers (60,94) between the orifice insert (24) and the nozzle inlet end (30).

### RELATED INVENTION

The present invention claims benefit under 35 U.S.C. §119(e) to “Atomizing Nozzle with Anodized Aluminum Body,” U.S. Provisional Patent Application Serial No. 60/436,711, filed Dec. 27, 2002, which is incorporated by reference herein.

### TECHNICAL FIELD OF THE INVENTION

The present invention relates generally to mist heads, which atomize pressurized fluid. Specifically, the present invention relates to atomizing nozzles that are configured to consistently produce a uniform fine mist.

### BACKGROUND OF THE INVENTION

Atomizing nozzles, also called mist heads, are used in connection with misting systems to produce a fog or fine mist. A fluid, typically water, is forced under pressure through the atomizing nozzles to produce the mist. Desirably, the mist is sufficiently fine so that it rapidly evaporates. As the mist evaporates, the general area around the atomizing nozzles becomes cooler. Rapid evaporation prevents people and property located in the mist from getting wet and enhances the cooling effect. Accordingly, misting systems are often used for cooling and for increasing humidity.

A conventional high-pressure atomizing nozzle is typically made up of a metallic nozzle body, a metallic orifice insert having a small opening or orifice, and an impeller (also called a plunger or poppet) positioned within a fluid chamber in the nozzle body. A fluid, typically water, is passed through the orifice under pressure to produce the desired fog or mist. The action of the impeller within the fluid chamber fractures the fluid and produces a finer fog or mist.

When metallic, the nozzle body is typically made of brass or copper. Brass and copper provide a readily worked material that is stable in the presence of air or water. While brass and copper may oxidize to form a patina, this patina has no significant expansion over the non-oxidized brass or copper. This causes channels and passages in the nozzle body to remain substantially as fabricated in size. In addition, the patina inhibits further oxidation, thereby preserving the nozzle body.

When other common metallic materials were used for the nozzle body, oxidation problems were encountered that limit the useful life of the nozzle. For example, iron and steel turn to rust. This rust is progressive, and over time will completely consume the nozzle body. In addition, the rust has a lower density than the iron or steel. This causes the rust to gradually reduce the sizes of channels and passages within the nozzle body, thereby limiting fluid flow.

Aluminum is a readily available, inexpensive, easily worked metal which, like brass or copper, produces a patina or oxide that inhibits further oxidation. Unfortunately, aluminum oxide has a lower density than aluminum. As a result, channels and passages within the nozzle body are reduced in size. To worsen the problem, aluminum tends to oxidize in a crystalline manner, i.e., in lumps. These lumps reduce the sizes of channels and passages in an unpredictable manner. This defeats efforts to compensate for the oxidization during manufacture.

In addition, the semi-crystalline lumps will often break loose under the influence of the fluid flow. When this occurs, the lumps are then free to pass through the nozzle and out the orifice. While these lumps are rarely of a size to clog the orifice, they pose another problem. The most common oxides of aluminum, aluminum oxide and aluminum dioxide, are very hard. In passing through the nozzle body and the orifice, these very hard lumps literally carve away the surfaces they encounter. This leads to premature failure of the atomizing head.

Because of the oxidization problems, aluminum has been rejected by the misting and spraying industries for nozzle use. Accordingly, conventional atomizing nozzles are produced with brass bodies and stainless-steel orifice inserts. Such nozzles are expensive to manufacture.

Additionally, brass is a relatively dense metal. A brass atomizing nozzle therefore exhibits a significant mass. This mass results in significant shipping charges.

There are materials that do not exhibit pronounced corrosion problems. None of these materials, however, are as readily available as aluminum, i.e., all are significantly more expensive, and few are as light as aluminum, i.e., most cost more to ship.

What is needed, therefore, is a method of producing an aluminum atomizing nozzle that circumvents the problems of corrosion while simultaneously maintaining the desired low density.

### SUMMARY OF THE INVENTION

Accordingly, it is an advantage of the present invention that an anodized aluminum atomizing nozzle and method for manufacture thereof are provided.

Another advantage of the present invention is that an atomizing nozzle is provided that has a nozzle body constructed of a first metal and an orifice insert fabricated of a second metal.

Another advantage of the present invention is that an atomizing nozzle is provided that has an orifice insert formed from stainless steel.

The above and other advantages of the present invention are carried out in one form by an atomizing nozzle for use in a misting system. The atomizing nozzle includes a nozzle body formed of anodized aluminum, encompassing a fluid chamber, and having a body inlet end and a body outlet end, a metallic orifice insert affixed to the nozzle body proximate the outlet end, and an impeller configured to reside within the fluid chamber.

The above and other advantages of the present invention are carried out in another form by a method of manufacturing an atomizing nozzle for use in a misting system. The method includes constructing an anodized aluminum nozzle body encompassing a first chamber, fabricating a metallic orifice insert encompassing a second chamber, producing an impeller, inserting the impeller into the first chamber, and affixing the orifice insert into the nozzle body.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a top view of an atomizing nozzle in accordance with a preferred embodiment of the present invention;

FIG. 2 shows a front view of the atomizing nozzle of FIG. 1 in accordance with a preferred embodiment of the present invention;

FIG. 3 shows a cross-sectional front view of the atomizing nozzle of FIG. 1 taken at line 3-3 with an O-ring removed in accordance with a preferred embodiment of the present invention;

FIG. 4 shows an exploded cross-sectional front view of the atomizing nozzle of FIG. 1 taken at line 3-3 in accordance with a preferred embodiment of the present invention;

FIG. 5 shows a flow chart of a process to manufacture the atomizing nozzle of FIG. 1 in accordance with a preferred embodiment of the present invention;

FIG. 6 shows a top view of an orifice insert for the atomizing nozzle of FIG. 1 in accordance with a preferred embodiment of the present invention;

FIG. 7 shows a top view of an impeller for the atomizing nozzle of FIG. 1 in accordance with a preferred embodiment of the present invention;

FIG. 8 shows a front view of the impeller of FIG. 7 in accordance with a preferred embodiment of the present invention;

FIG. 9 shows a cross-sectional front view of a portion of the atomizing nozzle of FIG. 3 taken above line 9-9 during insertion of an orifice insert into a nozzle body in accordance with a preferred embodiment of the present invention;

FIG. 10 shows a cross-sectional front view of a portion of the atomizing nozzle of FIG. 3 taken above line 9-9 after insertion of the orifice insert into the nozzle body in accordance with a preferred embodiment of the present invention; and

FIG. 11 shows a cross-sectional front view of the atomizing nozzle of FIG. 1 taken at line 3-3 during operation in accordance with a preferred embodiment of the present invention.

### DETAILED DESCRIPTION OF THE PREFERRED EMBODIMENTS

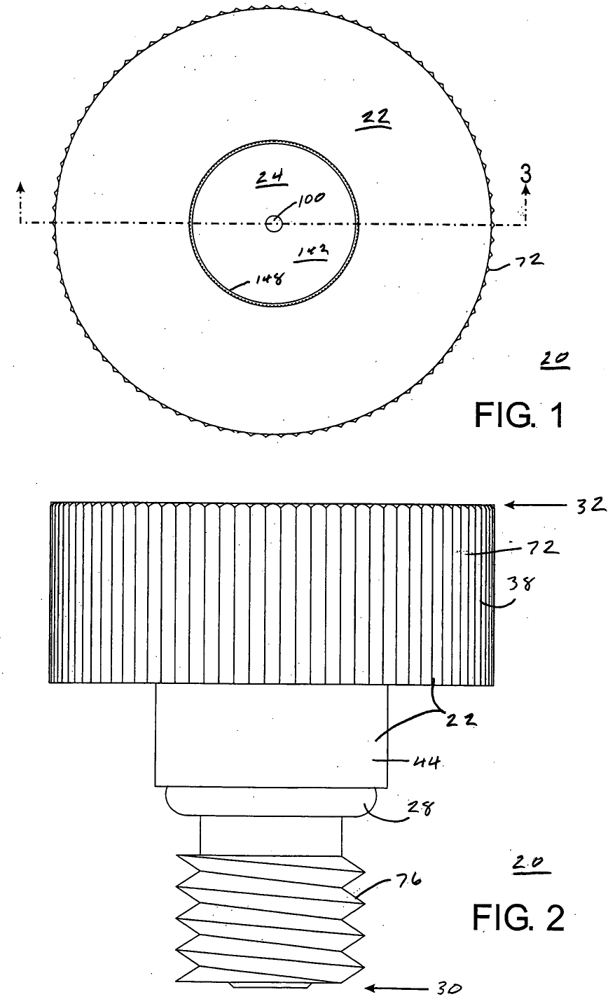

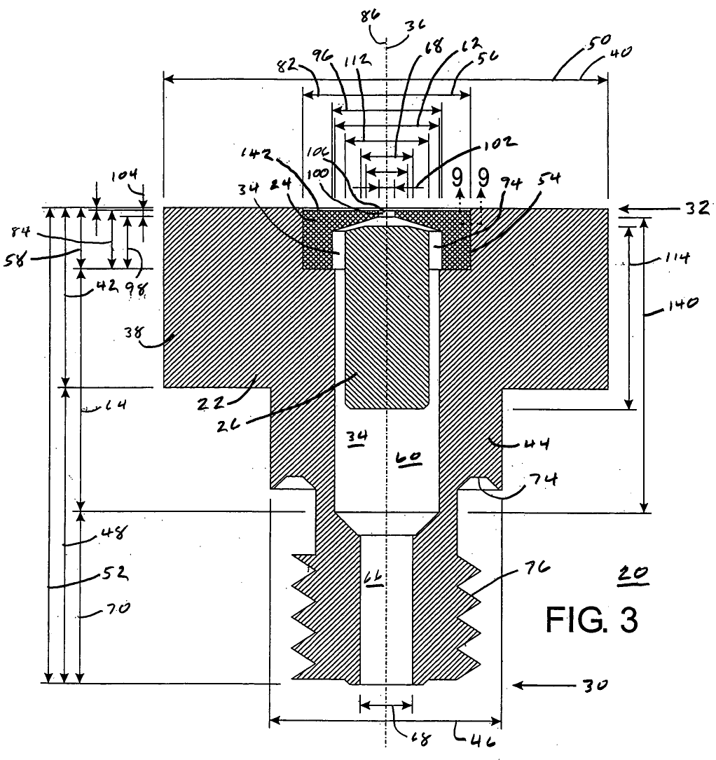

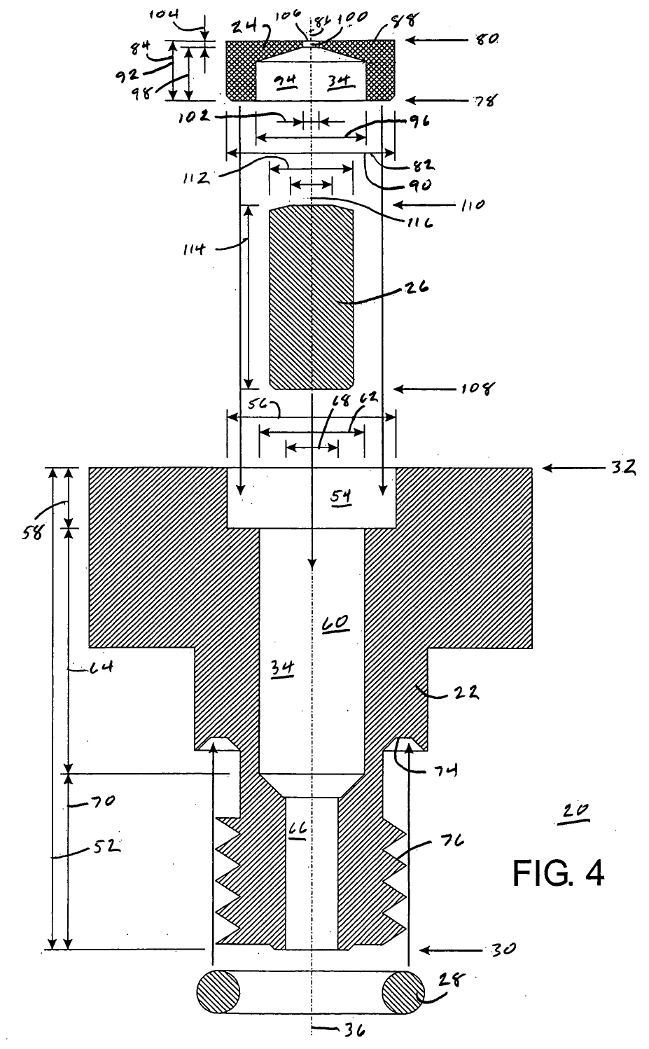

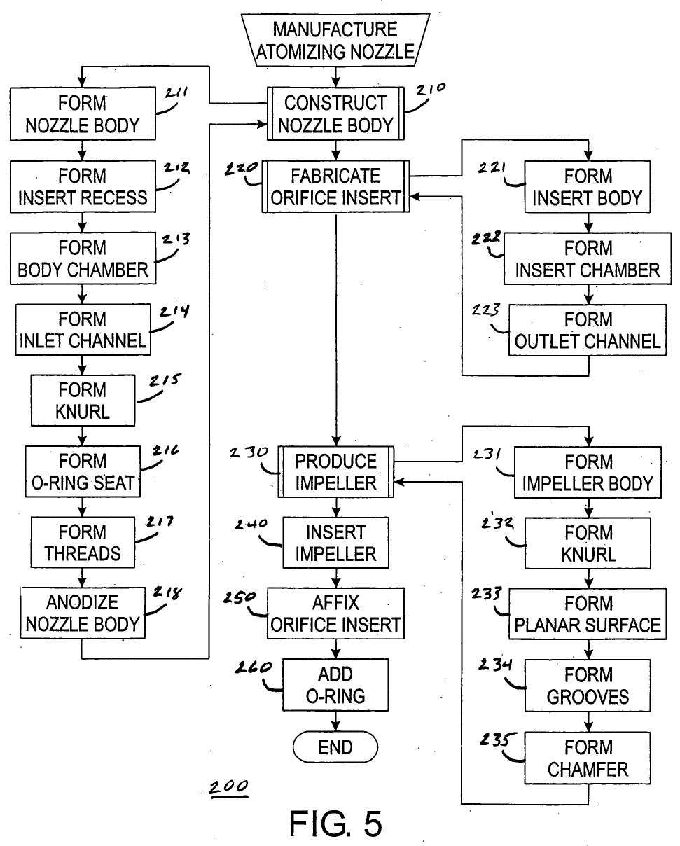

FIG. 1 shows a top view and FIG. 2 shows a front view of an atomizing nozzle in accordance with a preferred embodiment of the present invention. FIG. 3 shows an assembled and FIG. 4 shows an exploded cross-sectional front view of atomizing nozzle 20 taken at line 3-3 of FIG. 1. FIG. 5 shows a flow chart of a process 200 to manufacture atomizing nozzle 20 in accordance with a preferred embodiment of the present invention. The following discussion refers to FIGS. 1 through 5.

Atomizing nozzle 20 is configured for attachment to a pipe (not shown) in a misting system (not shown), thereby providing a fine mist or fog for cooling and/or hydration. Atomizing nozzle 20 is made up of a nozzle body 22, an orifice insert 24, an impeller 26 (also known as a plunger or poppet), and an O-ring 28. Nozzle body 22 has an inlet end 30 and an outlet end 32. Nozzle body 22 also encompasses a fluid chamber 34 between inlet end 30 and outlet end 32. Orifice insert 24 is affixed to nozzle body 22 proximate outlet end 32. Impeller 26 resides within fluid chamber 34 of nozzle body 22.

Atomizing nozzle 20 may be manufactured and assembled as delineated in process 200. The components of atomizing nozzle 20 are created and integrated by subprocesses within process 200.

In the preferred embodiment, atomizing nozzle 20 is rotationally symmetrical about an axis 36. Those skilled in the art will appreciate, however, that this is not a requirement of the present invention. The manufacture of an asymmetrical embodiment of atomizing nozzle 20 does not depart from the spirit of the present invention.

Nozzle body 22 is constructed by subprocess 210 of process 200. Subprocess 210 contains tasks 211, 212, 213, 214, 215, 216, 217, and 218 to form various features of nozzle body 22.

In task 211, subprocess 210 forms nozzle body 22 in raw (unfinished) form (not shown) from aluminum stock(not shown). In the preferred embodiment of the Figures, nozzle body 22 is a stepped right cylinder having a greater body portion 38 with a greater-portion diameter 40 and a greater-portion length 42, and a lesser body portion 44 with a lesser-portion diameter 46 and a lesser portion length 48. Greater-portion diameter 40 is greater than lesser-portion diameter 46.

Nozzle body 22 has a nozzle-body diameter 50 and a nozzle-body length 52. Nozzle-body diameter 50 is substantially equal to greater-portion diameter 40, and nozzle-body length 52 is substantially equal to a sum of greater-portion length 42 plus lesser-portion length 48.

Those skilled in the art will appreciate that forming nozzle body 22 as a stepped right cylinder is not a requirement of the present invention, and that other shapes for nozzle body 22 may be used without departing from the spirit of the present invention.

In task 212, subprocess 210 forms an insert recess 54 into nozzle body 22 proximate inlet end 32. In the preferred embodiment, insert recess 54 is substantially a right-cylindrical cavity formed about nozzle axis 36 and extending into nozzle body 22 from outlet end 32. Insert recess 54 has a recess diameter 56 and a recess length 58. Insert recess 54 is configured to contain orifice insert 24.

In task 213, subprocess 210 forms a body chamber 60. Body chamber 60 is substantially a right-cylindrical cavity formed about nozzle axis 36 and extending into nozzle body 22 from insert recess 54. Body chamber 60 has a body-chamber diameter 62 and a body-chamber length 64. It will be appreciated that other shapes may be used for body chamber 60. The use of another shape does not depart from the spirit of the present invention.

In task 214, subprocess 210 forms a fluid inlet channel 66. Inlet channel 66 is substantially a right-cylindrical cavity formed about nozzle axis 36 and extending through nozzle body 22 from body chamber 60 to inlet end 30. Inlet channel 66 has an inlet-channel diameter 68 and an inlet-channel length 70. It will be appreciated that other shapes may be used for fluid inlet channel 66. The use of another shape does not depart from the spirit of the present invention.

In task 215, subprocess 210 forms a knurl 72 around an outside of nozzle body 22. Knurl 72 serves to allow atomization nozzle 20 to be attached to and detached from the pipe (not shown) by hand. It will be appreciated that other methods of attachment and detachment may be possible or desirable. In this case, task 214 may form the desired shape or texture (e.g., a hexagonal shape) without departing from the spirit of the present invention.

In task 216, subprocess 210 forms a seat 74 for O-ring 28 in lesser body portion 44 of nozzle body 22. O-ring seat 74 is depicted in FIG. 3, from which O-ring 28 has been removed for clarity. O-ring 28 is depicted seated in O-ring seat 74 in FIG. 4.

In task 217, subprocess 210 forms threads 76 in lesser body portion 44 of nozzle body 22. Threads 76 serve to attach atomizing nozzle 20 to the pipe (not shown). It will be appreciated that other methods of attachment are possible and may be desirable in certain embodiments. In this case, task 214 may form the desired attachment means (e.g., a crimp fitting) without departing from the spirit of the present invention.

With the completion of tasks 211, 212, 213, 214, 215, 216, and 217 nozzle body 22 is completely formed of raw aluminum. Raw aluminum suffers from oxidation over time, which oxidation may interfere with the operation of atomizing nozzle 20. Therefore, in task 218, subprocess 210 anodizes nozzle body 22 to inhibit oxidation. Anodizing takes space, i.e., adds thickness to nozzle body 22. Those skilled in the art will appreciate that this added thickness is predictable and therefore may be compensated for in the construction of nozzle body 22.

Anodizing may be accomplished with the addition of colorants. While not a requirement of the present invention, the use of such colorants enhances the appearance of atomizing nozzle 20 and may therefore be considered a marketing factor.

Those skilled in the art will appreciate that in the preferred embodiment subprocess 210 involves machining the features formed by tasks 211, 212, 213, 214, 215, 216, and 217 using established techniques. The order of tasks 211, 212, 213, 214, 215, 216, and 217 within subprocess 210 is irrelevant to this discussion. It will also be appreciated that other methods of effecting subprocess 210 may be used without departing from the spirit of the present invention.

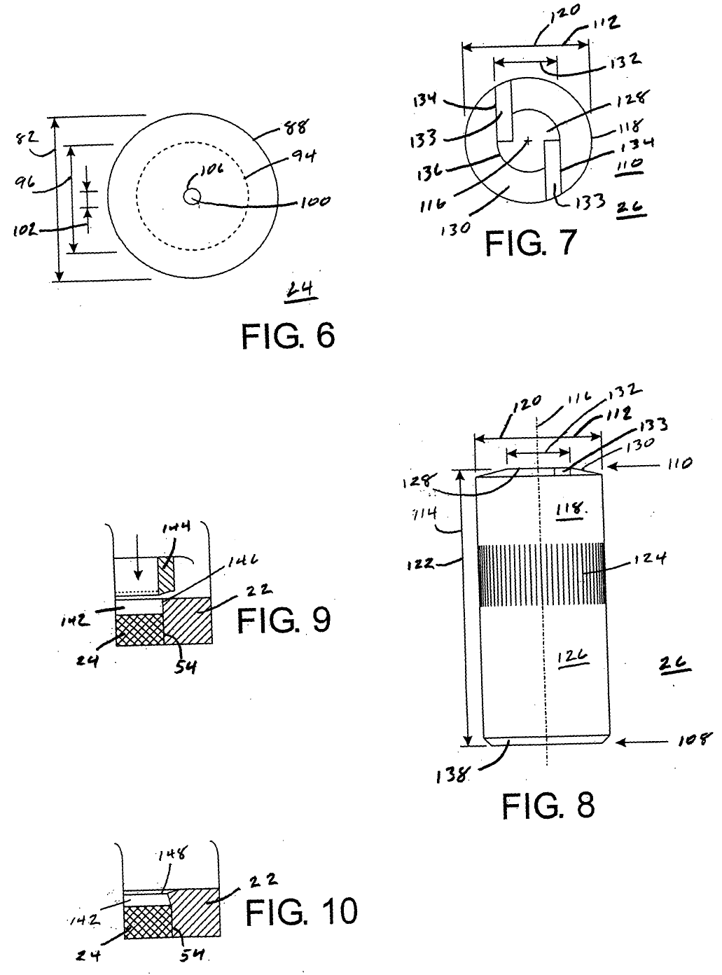

FIG. 6 shows a top view of orifice insert 24 for the atomizing nozzle 22 in accordance with a preferred embodiment of the present invention. The following discussion refers to FIGS. 3, 4, 5, and 6.

Orifice insert 24 is fabricated by subprocess 220 of process 200. Subprocess 220 contains tasks 221, 222, and 223 to form various features of orifice insert 24. In the preferred embodiment, orifice insert 24 takes the form of a right-cylindrical cup having an insert inlet end 78, an insert outlet end 80, an insert diameter 82, an insert length 84 and an insert axis 86. Desirably, insert diameter 82 is substantially equal to recess diameter 56, and insert length 84 is less than recess length 58. When orifice insert 24 is within nozzle body 22, insert axis 86 is substantially coincident with nozzle axis 36.

In task 221, subprocess 220 forms a body 88 of orifice insert 24. In the preferred embodiment, insert body 88 is substantially a right-cylindrical plug formed about insert axis 86. Insert body 88 has an insert-body diameter 90 and an insert-body length 92.

In task 222, subprocess 220 forms a chamber 94 within insert 24. In the preferred embodiment, insert chamber 94 is substantially a right-cylindrical cavity with a right-conical end formed about insert axis 86 and extending into insert body 88 from insert inlet end 78. Insert chamber 94 has an insert-chamber diameter 96 and an insert-chamber length 98. It will be appreciated, however, that other shapes may be used for insert chamber 94. The use of another shape does not depart from the spirit of the present invention.

In task 223, subprocess 220 forms an outlet channel 100 within orifice insert 24. In the preferred embodiment, outlet channel 100 is substantially a right-cylindrical cavity formed about insert axis 86 and extending through orifice insert 24 from insert chamber 94 to insert outlet end 80. Outlet channel 100 has an outlet-channel diameter 102 and an outlet-channel length 104. An outside end of outlet channel 100 (i.e., the end at insert outlet end 80) forms an orifice 106.

Orifice insert 24 is a metallic orifice insert. That is, orifice insert 24 is fabricated of metal. Desirably, orifice insert 24 is fabricated of a metal or an alloy of metals that is substantially non-reactive to air or water (or other fluid to be atomized by atomizing nozzle 20). By being substantially non-reactive, corrosion is kept to a minimum, and the useful lifetime of atomizing nozzle 20 is maximized. Desirably, orifice insert 24 is fabricated of a metal harder than the material of which nozzle body 22 is fabricated. In the preferred embodiment, nozzle body 22 is fabricated of aluminum and orifice insert 24 is fabricated of stainless steel. Those skilled in the art will appreciate that orifice insert may be fabricated of other materials, e.g., alloys of aluminum, titanium, and magnesium, without departing from the spirit of the present invention.

Subprocess 220, the fabrication of orifice insert 24, is complete. Insert-body diameter 90 is insert diameter 82, and insert-body length 92 is insert length 84.

Those skilled in the art will appreciate that subprocess 220 may involve machining or otherwise producing the features formed by tasks 221, 222, and 223 using established techniques. It will also be appreciated that the order of tasks 221, 222, and 223 within subprocess 220 is irrelevant to this discussion.

FIG. 7 shows a top view and FIG. 8 shows a front view of impeller 26 for atomizing nozzle 22 in accordance with a preferred embodiment of the present invention. The following discussion refers to FIGS. 3, 4, 5, 7, and 8.

Impeller 26 is fabricated by subprocess 230 of process 200. Subprocess 230 includes tasks 231, 232, 233, 234, and 235 to form various features of impeller 26. In the preferred embodiment, impeller 26 takes the form of a right cylindroid having an impeller inlet end 108, an impeller outlet end 110, an impeller diameter 112, an impeller length 114 and an impeller axis 116. When impeller 26 is centered within nozzle body 22, impeller axis 116 is substantially coincident with nozzle axis 36.

In task 231, subprocess 230 forms an impeller body 118 of impeller 26. In the preferred embodiment, impeller body 118 is a substantially right cylindroid formed about impeller axis 116. Impeller body 118 has an impeller-body diameter 120 substantially equal to impeller diameter 112, and an impeller-body length 122 substantially equal to impeller length 114.

In task 232, subprocess 230 forms a knurl 124 around an outside surface 126 of impeller body 118. Impeller knurl 124 serves to fracture the water or other fluid during operation. Those skilled in the art will appreciate that knurl 124 is not a requirement of the present invention. The omission of task 232, and of knurl 124, does not depart from the spirit of the present invention.

In task 233, subprocess 230 forms a substantially circular planar surface 128 at impeller outlet end 110 of impeller body 118. This is achieved by producing an impeller bevel 130 about impeller axis 116 on impeller outlet end 110. This results in a substantially circular planar surface 128 having a surface diameter 132 less than impeller diameter 112.

In task 234, subprocess 230 forms grooves 133 at impeller outlet end 110 of impeller body 118. In the preferred embodiment, grooves 133 have an outer edge 134, which is substantially tangential to a circumference 136 of planar surface 128. Grooves 133 serve to further fracture the water or other fluid during operation.

And in task 235, subprocess 230 forms a chamfer 138 at impeller inlet end 108 of impeller body 118. Chamfer 138 aids in the insertion of impeller 26 into nozzle body 22. Those skilled in the art will appreciate that knurl 72 is not a requirement of the present invention. The omission of task 235, and of chamfer 138, does not depart from the spirit of the present invention.

Those skilled in the art will appreciate that, depending upon the material of which impeller 26 is fabricated, subprocess 230 may involve molding, machining, or otherwise producing the features formed by tasks 231, 232, 233, 234, and/or 235 using established techniques. It will also be appreciated that the order of tasks 231, 232, 233, 234, and/or 235 within subprocess 230 is irrelevant to this discussion. For example, tasks 231, 232, 233, 234, and 235 may be performed substantially simultaneously if subprocess 230 fabricates impeller 26 by molding.

Those skilled in the art will appreciate that the order in which subprocesses 210, 220, and 230 are performed, i.e., the order in which nozzle body 22, orifice insert 24, and impeller 26 are fabricated, is irrelevant. Changing the order from that exemplified in this discussion does not depart from the spirit of the present invention.

The following discussion refers to FIGS. 3 and 4.

Fluid chamber 34 is formed of insert chamber 94 and body chamber 60. Impeller 26 is configured to reside within fluid chamber 34. In order to fulfill its function, impeller 26 needs to be able to spin, vibrate, and otherwise move within fluid chamber 34. Therefore, fluid chamber 34 should have a diameter greater than impeller diameter 112 and a length greater than impeller length 114.

Insert chamber 94 has insert-chamber diameter 96. Body chamber 60 has body-chamber diameter 62. Body-chamber diameter 62 is substantially equal to or less than insert-chamber diameter 96.

Fluid chamber 34 is formed by concatenating insert chamber 94 and body chamber 60. Insert chamber 94 has insert-chamber length 98 and body chamber 60 has body-chamber length 64. Therefore, fluid chamber 34 has a length 140 that is the sum of insert-chamber length 98 and body-chamber length 64.

Impeller 26 must be free to move inside fluid chamber 34. Therefore, impeller diameter 112 is less than either body-chamber diameter 62 or insert-chamber diameter 96. Similarly, impeller length 114 is less than fluid-chamber length 140.

Fluid chamber 34 is bound on one end by outlet channel 100 and on the other end by inlet channel 66. Since it is desirable that impeller 26 be retained within fluid chamber 34, impeller diameter 112 is greater than either outlet-channel diameter 102 or inlet-channel diameter 68.

With the completion of subprocesses 210, 220 and 230, the principal components of atomizing nozzle 20 are ready for assembly.

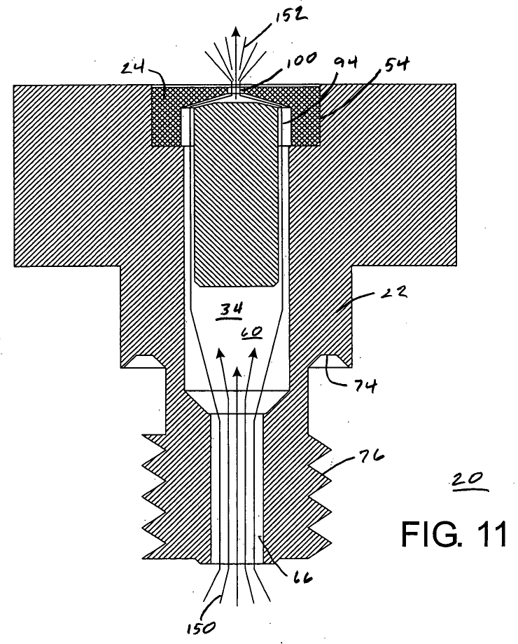

FIGS. 9 and 10 show cross-sectional front views of a portion of atomizing nozzle 20 taken above line 9-9 of FIG. 3 during (FIG. 9) and after (FIG. 10) insertion of orifice insert 24 into nozzle body 22 in accordance with a preferred embodiment of the present invention. The following discussion refers to FIGS. 3, 4, 5, 9, and 10.

In a task 240 of process 200, impeller 26 is inserted into body chamber 60 of nozzle body 22. Inlet end 108 of impeller 26 is inserted into body chamber 60 through insert recess 54. Chamfer 138 serves to guide impeller 26 into body chamber 60. Since impeller diameter 112 is greater than inlet channel diameter 68, impeller 26 is inhibited from entering inlet channel 66 and remains in body chamber 60.

In a task 250 of process 200, orifice insert 24 is affixed to nozzle body 22. In the preferred embodiment, nozzle body 22 is fabricated of anodized aluminum and orifice insert 24 is fabricated of stainless steel. It will be appreciated, however, that stainless steel is not a requirement of the present invention and orifice insert may be fabricated of other materials without departing from the spirit of the present invention.

Orifice insert 24 is inserted into insert recess 54 or nozzle body 22. Desirably, orifice insert 24 and insert recess 54 are dimensioned so that insert diameter 90 is substantially equal to recess diameter 56. This allows orifice insert 24 to be press-fitted into insert recess 54 in a manner well known to those skilled in the art.

In the preferred embodiment, insert length 92 is less than recess length 58. When orifice insert 24 is pressed to the bottom of insert recess 54, a mounting recess 142 is left. A crimping or riveting tool 144 (FIG. 9) may then be used to distort an edge 146 of mounting recess 142 (i.e., of insert recess 54). Distorted edge 148 (FIG. 10) then entraps orifice insert 24 inside of insert recess 54.

As discussed hereinbefore insert-chamber diameter 96 is desirably greater than or equal to body chamber diameter 62. This inhibits impeller 26 from catching upon orifice insert 24 during insertion or operation.

Those skilled in the art will appreciate that other methods of affixing orifice insert 24 to or into nozzle body 22 may be used without departing from the spirit of the present invention.

In a final task 260, O-ring 28 is added to atomizing nozzle 20. O-ring 28, in conjunction with O-ring seat 74, allows atomizing nozzle 20 to make a watertight connection with a pipe (not shown) of the misting system (not shown).

Those skilled in the art will appreciate that the method of assembling atomizing nozzle 20 described hereinbefore is exemplary only, and that a plurality of other, equally valid methods may be used. The use of another method of assembly does not depart from the spirit of the present invention.

FIG. 11 shows a cross-sectional front view of atomizing nozzle 20 taken at line 3-3 of FIG. 1 during operation in accordance with a preferred embodiment of the present invention. The following discussion refers to FIG. 11.

When atomizing nozzle 20 is connected to a pipe (not shown) of a misting system (not shown) and pressure is applied, water 150 (or other fluid) is forced into fluid inlet channel 66. From fluid inlet channel 66, water 150 enters fluid chamber 34. In fluid chamber 34, water 150 flows around impeller 26, imparting spin, vibration, and other motions to impeller 26. The motions of impeller 26 cause water 150 to fracture, i.e., produces cavitation of water 150. Fractured water 150 flows from fluid chamber 34 into outlet channel 100. Water 150 then exits outlet channel 100 via orifice 106 as a fine mist or fog 152.

In summary, the present invention teaches an anodized aluminum atomizing nozzle 20 and a process 200 for its manufacture. Atomizing nozzle 20 is provided having an orifice insert 24 and an impeller 26. Nozzle body 22 of atomizing nozzle 20 is fabricated of aluminum and anodized to resist corrosion.

Although the preferred embodiments of the invention have been illustrated and described in detail, it will be readily apparent to those skilled in the art that various modifications may be made therein without departing from the spirit of the invention or from the scope of the appended claims.

What is claimed is:

1. An atomizing nozzle for use in a misting system, said atomizing nozzle comprising:
a nozzle body formed of anodized aluminum, encompassing a fluid chamber, and having a body inlet end and a body outlet end;
a metallic orifice insert affixed to said nozzle body proximate said body outlet end; and
an impeller configured to reside within said fluid chamber.

2. An atomizing nozzle as claimed in claim 1 wherein said nozzle body comprises:
an insert recess proximate said body outlet end;
a body chamber configured to form at least a portion of said fluid chamber and formed in concatenation with said insert recess; and
a fluid inlet channel proximate said body inlet end and formed in concatenation with said body chamber.

3. An atomizing nozzle as claimed in claim 1 wherein said orifice insert comprises:
a substantially cylindrical insert body having an insert inlet end and an insert outlet end;
a substantially cylindrical insert chamber substantially coaxially formed within said insert body proximate said insert inlet end;
a substantially conical bevel substantially coaxially formed within said insert body proximate said insert outlet end; and
a substantially cylindrical outlet channel substantially coaxially formed within said insert body between said insert chamber and said insert outlet end.

4. An atomizing nozzle as claimed in claim 1 wherein said anodized aluminum is a first metal, and wherein said orifice insert is fabricated of a second metal.

5. An atomizing nozzle as claimed in claim 4 wherein said second metal is stainless steel.

6. An atomizing nozzle as claimed in claim 1 wherein:
said nozzle body comprises a body chamber;
said orifice insert comprises an insert chamber; and
said fluid chamber is formed of a concatenation of said body chamber and said fluid chamber.

7. An atomizing nozzle as claimed in claim 1 wherein said fluid chamber comprises:
a substantially cylindrical first chamber having a first chamber length, and having a first chamber diameter; and
a substantially cylindrical second chamber having a second chamber length and having a second chamber diameter greater than or equal to said first chamber diameter.

8. An atomizing nozzle as claimed in claim 7 wherein said fluid chamber has a fluid chamber length substantially equal to a sum of said first chamber length and said second chamber length.

9. An atomizing nozzle as claimed in claim 7 wherein:
said nozzle body comprises an inlet channel having an inlet channel diameter;
said orifice insert comprises an outlet channel having an outlet channel diameter; and
said impeller has an impeller diameter and an impeller length, wherein;
said impeller diameter is greater than said inlet channel diameter;
said impeller diameter is greater than said outlet channel diameter;
said impeller diameter is less than said first chamber diameter; and
said impeller length is less than a sum of said first and second chamber lengths.

10. An atomizing nozzle as claimed in claim 1 wherein said impeller comprises:
an impeller length;
an impeller diameter;
an impeller inlet end;
an impeller outlet end, wherein said impeller inlet end is closer to said nozzle inlet end than said nozzle outlet end when said non-metallic impeller resides within said fluid chamber;
a planar surface at said impeller outlet end, wherein said planar surface is substantially circular, has a surface circumference, and has a surface diameter less than said impeller diameter; and
a plurality of grooves at said impeller outlet end, where each of said grooves has an outer edge substantially tangential to said surface circumference.

11. A method of manufacturing an atomizing nozzle for use in a misting system, said method comprising:
constructing an anodized aluminum nozzle body encompassing a first chamber;
fabricating a metallic orifice insert encompassing a second chamber;
producing an impeller;
inserting said impeller into said first chamber; and
affixing said orifice insert into said nozzle body.

12. A method as claimed in claim 11 wherein said constructing activity comprises:
forming an insert recess within said nozzle body, wherein said insert recess is substantially cylindrical and has a recess diameter;
forming said first chamber first within said nozzle body, wherein said first chamber is substantially cylindrical and has a first-chamber diameter less than said recess diameter;
forming an inlet channel within said nozzle body, wherein said inlet channel is substantially cylindrical and has an inlet-channel diameter less than said first-chamber diameter, and wherein said first chamber and said inlet channel are contiguous and substantially coaxial; and
anodizing said nozzle body.

13. A method as claimed in claim 12 wherein said non-metallic impeller has an impeller diameter less than said first-chamber diameter and greater than said inlet-channel diameter.

14. A method as claimed in claim 12 wherein said constructing activity additionally comprises forming threads upon said nozzle body.

15. A method as claimed in claim 11 wherein:
said constructing activity comprises forming an insert recess within said nozzle body; and
said affixing activity affixes said metallic orifice insert within said insert recess.

16. A method as claimed in claim 11 wherein said affixing activity affixes said orifice insert to said nozzle body by one of crimping and riveting.

17. A method as claimed in claim 11 wherein said fabricating activity comprises:
forming an insert body for said metallic orifice insert;
forming said second chamber as substantially a right cylinder within said insert body; and
forming an outlet channel within said insert body, wherein said outlet channel extends between said second chamber and an outside of said insert body.

18. A method as claimed in claim 11 wherein said producing activity comprises:
forming said impeller as substantially a cylinder having an impeller diameter;
forming a raised planar surface at a first end of said impeller, wherein said raised planar surface is substantially circular, has a surface circumference, and has a surface diameter less than said impeller diameter; and
forming a plurality of grooves at said first end of said impeller, wherein each of said grooves has an outer edge substantially tangential to said surface circumference.

19. A method as claimed in claim 11 wherein:
said constructing activity constructs said nozzle body of aluminum; and
said fabricating activity fabricates said metallic orifice insert of stainless steel.

20. An atomizing nozzle for use in a misting system, said atomizing nozzle comprising:
an anodized aluminum nozzle body having an inlet end, having an outlet end, having an insert recess proximate said outlet end, and encompassing a first portion of a fluid chamber;
a stainless steel orifice insert affixed to said nozzle body within said insert recess and encompassing a second portion of said fluid chamber; and
an impeller configured to reside within said fluid chamber.
